(19) United States
(12) Patent Application Publication
(10) Pub. No.: US 2024/0411205 A1
(43) Pub. Date: Dec. 12, 2024

(54) ANTI-SHAKE MOTOR, CAMERA MODULE, AND ELECTRONIC DEVICE

(71) Applicant: CHIPSEMI SEMICONDUCTOR (NINGBO) CO., LTD., Ningbo (CN)

(72) Inventors: Yulin Zhang, Ningbo (CN); Yaoguo Zhang, Ningbo (CN); Bo Xia, Ningbo (CN); Bo Nie, Ningbo (CN)

(21) Appl. No.: 18/807,999

(22) Filed: Aug. 18, 2024

Related U.S. Application Data
(63) Continuation of application No. PCT/CN2022/117287, filed on Sep. 6, 2022.

(30) Foreign Application Priority Data
May 10, 2022 (CN) 202210502038.3

(51) Int. Cl. G03B 5/00; G02B 27/64

(52) U.S. Cl. CPC G03B 5/00; G02B 27/646; G03B 2205/0069

(57) ABSTRACT

The present application discloses an anti-shake motor, a camera module, and electronic equipment. The anti-shake motor includes a base, an anti-shake bracket, a circuit board, and a conductive electrode plate. The anti-shake bracket is movably set on the base within a predetermined plane and has a conductive magnetic component. The circuit board is set on the base with a coil that drives the magnetic component to move the anti-shake bracket within the predetermined plane. The conductive electrode plate is set on the circuit board, forming a capacitor with the magnetic component, which is electrically connected to the circuit board to output the capacitive signal formed with the conductive electrode plate. The anti-shake motor, camera module, and electronic equipment provided in this embodiment can achieve closed-loop control of the anti-shake motor while minimizing internal space occupation.

### CROSS-REFERENCE TO RELATED APPLICATIONS

This application is a continuation of International Application No. PCT/CN2022/117287, filed on Sep. 6, 2022, which claims the benefit of the Chinese Application with application number 2022105020383, filed on May 10, 2022, the disclosure of which is herein incorporated by reference in its entirety for all purposes.

### TECHNICAL FIELD

The present application relates to camera technology, specifically to an anti-shake motor, a camera module, and an electronic device.

### BACKGROUND

As electronic products continue to evolve with regular updates and upgrades, users are demanding increasingly higher photography capabilities. To meet these expectations, many electronic devices now include optical image stabilization (OIS) in their camera modules to enhance photography performance. In these camera modules, the anti-shake motor plays a crucial role by moving the lens vertically along the optical axis. This movement compensates for any camera shake, thereby maintaining image quality during photography.

To achieve closed-loop control in the anti-shake motor, a Hall sensor or a drive IC (Integrated Circuit) with Hall detection capability, along with a corresponding sensing magnet, is sometimes incorporated into the motor to detect lens movement in the vertical direction along the optical axis. The detection signals generated by this setup are then used to control the lens movement, ensuring the effectiveness of the anti-shake function in the camera module. However, this approach consumes valuable internal space within the anti-shake motor, which restricts the size of the drive IC and hampers the enhancement of the motor's drive force.

Therefore, a key challenge is how to minimize the internal space occupied by the anti-shake motor while implementing closed-loop control.

### SUMMARY

As a first aspect, the present application discloses an anti-shake motor including a base, an anti-shake bracket, a circuit board, and a conductive electrode plate. The anti-shake bracket is mounted on the base movable within a predetermined plane, and the anti-shake bracket has a conductive magnetic component. The circuit board, also mounted on the base, features a coil designed to drive the magnetic component, thereby enabling the movement of the anti-shake bracket within the predetermined plane. The conductive electrode plate, situated on the circuit board, forms a capacitor with the magnetic component. The magnetic component is electrically connected to the circuit board, which outputs the capacitance signal generated by the interaction between the magnetic component and the conductive electrode plate.

As a second aspect, the present application discloses a camera module that, in addition to the previously described anti-shake motor, also includes a lens holder connected to the anti-shake bracket. The lens holder features a mounting hole where the lens is securely positioned. The camera module further includes a driving chip, which is electronically connected to the circuit board. The driving chip receives the capacitance signal and, based on this signal, sends a control signal to the circuit board for the control coil.

As a third aspect, the present application discloses an electronic device, including the camera module described above.

The anti-shake motor, camera module, and electronic device described in this application generate a capacitance signal that corresponds to the movement of the magnetic component. This is achieved through a capacitor formed between the magnetic component and a conductive electrode plate, utilizing the magnetic component's conductivity. This design enables accurate detection of the anti-shake bracket's position while avoiding the issues associated with Hall detection, such as susceptibility to external magnetic field interference and temperature fluctuations. It also eliminates the need for additional mathematical processing when magnets are not used as capacitor electrode plates. As a result, the structure of the anti-shake motor is optimized for closed-loop control, reducing the number of parts and minimizing internal space usage, all while ensuring sufficient driving force.

Additionally, there are multiple magnetic components, some of which are distributed in sequence along the first direction, and others along the second direction. The first direction is perpendicular to the second direction, and both are parallel to the predetermined plane. There are multiple coils and conductive electrode plates, each corresponding to a magnetic component. Thus, when the anti-shake bracket moves in the first direction, the second direction, or in a direction resulting from the combined forces of the first and second directions, position detection is achieved through the capacitance signal formed by the magnetic components in different directions and the corresponding conductive electrode plates.

Furthermore, the orthogonal projection of the conductive electrode plate distributed along the first direction on the corresponding magnetic component falls at least partly outside the edge of the magnetic component in the first direction, and within the edge of the magnetic component in the second direction. Throughout the entire movement of the magnetic component in the second direction, the orthogonal projection of the conductive electrode plate consistently remains fully within the boundaries of the edge of the magnetic component. In other words, the design ensures that the conductive electrode plate is strategically positioned relative to the magnetic component. When viewed in the first direction, the orthogonal projection of the conductive electrode plate extends partly beyond the edge of the magnetic component, but remains within the boundary in the second direction. As the magnetic component moves along the second direction, its entire movement remains within the edge of the magnetic component in that direction.

Similarly, the orthogonal projection of the conductive electrode plate in the second direction on the corresponding magnetic component falls partly outside the edge in the second direction and fully within the boundaries of the edge the magnetic component in the first direction. Throughout the entire movement of the magnetic component in the first direction, the orthogonal projection of the conductive electrode plate remains within the boundaries of the edge of the magnetic component.

This arrangement allows for accurate position detection of the anti-shake bracket in both directions, by generating capacitance signals based on the interaction between the conductive electrode plates and the corresponding magnetic components. This dual-directional detection ensures precise tracking of the movements and positions of the anti-shake bracket.

Optionally, at least two magnetic components are positioned along the first and/or second directions. This arrangement allows for differential processing of the capacitance signals generated by these magnetic components and their corresponding conductive electrode plates. By comparing these capacitance signals, the accuracy of the position detection for the anti-shake bracket is significantly improved.

Optionally, the conductive electrode plate may be a copper overlay on the surface of the circuit board. This allows the configuration of the conductive electrode plate without affecting the magnetic field between the coil and the magnetic component.

Optionally, the coil may be positioned on the surface of the circuit board, opposite the magnetic component, with the conductive electrode plate located between the coil and the magnetic component. This arrangement optimizes internal space within the anti-shake motor, preventing interference with the design and installation of other components.

Optionally, the magnetic component may include a magnet with a metal layer, typically nickel plating, on its surface. The nickel layer, due to its conductive properties, facilitates the formation of a capacitor in conjunction with the conductive electrode plate, thereby generating a capacitance signal that corresponds to the movement of the magnet.

Optionally, the anti-shake motor may include a suspension wire assembly that connects the anti-shake bracket to the base, which provides support for the motor through the suspension wire assembly. The magnetic component is electrically connected to the circuit board via this suspension wire assembly, facilitating the transmission of electrical signals. This configuration allows the capacitance signal, generated by the interaction between the conductive electrode plate and the magnetic component, to be transmitted to the camera module's driving chip via the circuit board.

### BRIEF DESCRIPTION OF THE DRAWINGS

The accompanying figures (Figs.) illustrate embodiments and explain principles of the disclosed embodiments. It is to be understood, however, that these figures are presented for purposes of illustration only, and not for defining limits of relevant applications.

FIG. 1 is a schematic diagram of the structure of an anti-shake motor according to some embodiments of this application.

FIG. 2 is a schematic diagram of the distribution structure of magnetic components and coils within the anti-shake motor according to some embodiments of this application.

FIG. 3 is a schematic diagram of the fitting structure of magnetic components and conductive plates within the anti-shake motor according to some embodiments of this application.

FIG. 4 is a schematic diagram of the distribution structure of magnetic components, conductive plates, and coils within the anti-shake motor according to some embodiments of this application.

FIG. 5 is a schematic diagram of the connection structure of the suspension wire assembly, spring piece assembly, and circuit board within the anti-shake motor according to some embodiments of this application.

FIG. 6 is a schematic diagram of the structure of a camera module according to some embodiments of this application.

### DETAILED DESCRIPTION OF THE INVENTION

To make the objectives, technical solutions, and advantages of this application more clear, the various embodiments of this application will be described in detail below with reference to the accompanying drawings. However, it is understood by those skilled in the art that numerous technical details have been provided in the embodiments to help readers better understand the application. Nevertheless, the technical solutions claimed in this application can still be realized without these technical details and based on various changes and modifications to the following embodiments. The division of the following embodiments is for convenience of description and should not impose any limitation on the specific implementation of this application. Each embodiment can be combined and referenced with each other as long as there is no contradiction.

The anti-shake motor is a critical component in camera modules, essential for achieving optical image stabilization and thereby enhancing photo quality. This motor functions by driving both the anti-shake bracket and the lens bracket to move together vertically along the optical axis. Stabilization is achieved through the generation of electromagnetic force via coils and magnetic components.

To implement closed-loop control of the anti-shake motor, a Hall sensor or a drive IC equipped with Hall detection capabilities, along with a corresponding sensing magnet, is typically integrated within the motor. The motor detects the position of the anti-shake bracket by monitoring changes in magnetic flux during stabilization. Based on the detected position, the current in the coil is adjusted to ensure the anti-shake bracket reaches the stabilization position quickly and accurately.

However, this conventional approach takes up considerable internal space within the anti-shake motor, limiting the size of the coil and magnetic components. Moreover, the precision of the closed-loop control can be compromised by external magnetic interference and temperature variations, as these factors can affect the accuracy of magnetic field detection.

In other known approaches, the position of the anti-shake bracket is detected by placing capacitor plates within the anti-shake motor and using the capacitance signals they generate. However, the capacitor plates are usually positioned at a 45-degree angle relative to the electromagnetic force direction of the coil and magnetic components, which necessitates additional mathematical processing in the algorithm to accurately relate the detection signal to the displacement. Furthermore, this approach requires extra rotor and stator capacitor plates inside the anti-shake motor, adding complexity to the design and assembly.

To address the issue of excessive internal space consumption during the closed-loop control process, this application proposes an alternative solution. Conductive capacitor plates are integrated into the circuit board containing the coils within the anti-shake motor. The position of the anti-shake bracket is then detected through the capacitance signals generated by these conductive capacitor plates in conjunction with the magnetic components.

This new approach allows the magnetic components, which work with the coils to produce electromagnetic force, to form a capacitor with the conductive capacitor plates. The resulting capacitance signals correspond to the movement of the magnetic components, enabling accurate position detection of the anti-shake bracket. This new method minimizes interference from external magnetic fields and temperature fluctuations, issues commonly associated with Hall effect sensors, and eliminates the need for complex mathematical processing required when using non-magnetic capacitor plates. Consequently, this new design optimizes the structure of the anti-shake motor, reducing the number of required components, conserving internal space, and ensuring sufficient driving force for the motor during closed-loop control.

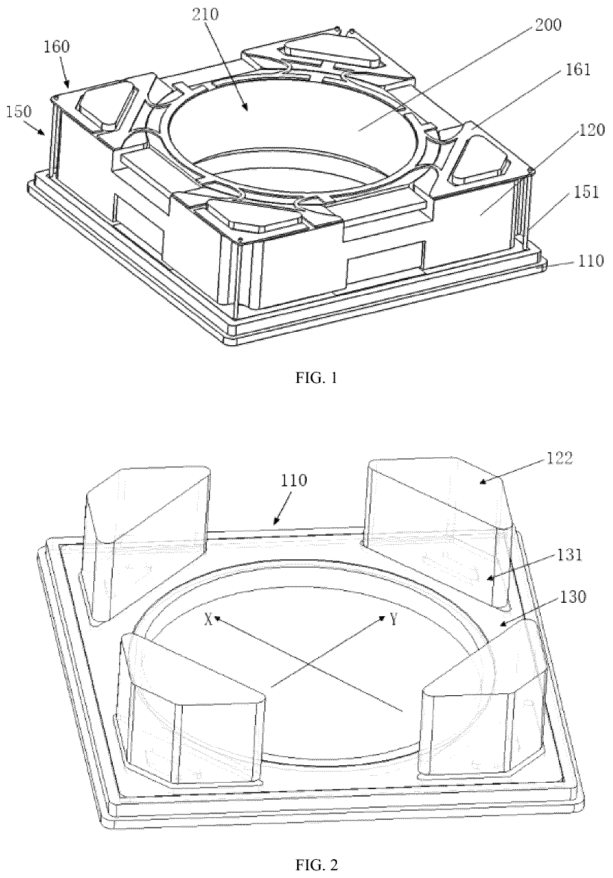

As shown in FIGS. 1 to 3, the anti-shake motor according to some embodiments of this application consists of several key components: a base (110), an anti-shake bracket (120), a circuit board (130), and conductive capacitor plates (140). The anti-shake bracket (120) is mounted on the base (110) and can move within a predetermined plane. It is equipped with a conductive magnetic component (122). The circuit board (130) is also mounted on the base (110) and includes a coil (131), which drives the movement of the magnetic component (122), and consequently, the anti-shake bracket (120), within the predetermined plane. Additionally, the conductive capacitor plates (140) are positioned on the circuit board (130). These plates, together with the magnetic component (122), form a capacitor. The magnetic component (122) is electrically connected to the circuit board (130) and transmits the capacitance signal, generated with the conductive capacitor plates (140), through the circuit board (130).

Base 110 is a component in the anti-shake motor that provides support and serves as a foundation for mounting other components. The overall shape of base 110 is hollow, with a light transmission hole in the middle to allow light to pass through. The outer contour of base 110 may be rectangular or other applicable shapes (square, round, etc). Optionally, base 110 can have a stepped structure to prevent dust from easily entering the interior of the anti-shake motor.

The anti-shake bracket 120 is an essential component in the anti-shake motor, responsible for facilitating anti-shake movement. Notably, the anti-shake bracket 120 features a light transmission hole that aligns with a corresponding hole in the base 110, both extending along the same direction—the optical axis of the lens. To perform its anti-shake function, the anti-shake bracket 120 is mounted on base 110 in such a way that it can move within a predetermined plane, which is perpendicular to the optical axis of the lens. The movement of the anti-shake bracket 120 is powered by the electromagnetic force generated between the magnetic component 122 and the coil 131. Moreover, the anti-shake bracket 120 is attached to a lens bracket 200, which securely holds the lens in place.

The circuit board 130 is responsible for transmitting electrical signals and arranging electronic components in the anti-shake motor. To avoid obstructing the movement of the anti-shake bracket 120, the circuit board 130 can be in the form of an FPC (Flexible Printed Circuit). The coil 131 can be arranged on the circuit board 130. During the process of energizing the coil 131, it is subjected to the magnetic field of the magnetic component 122, generating Lorentz force, which drives the magnetic component 122 and moves the anti-shake bracket 120 to achieve anti-shake.

The conductive electrode plate 140 is a component on the circuit board 130 that works in conjunction with the magnetic component 122 to form a capacitor. Due to the conductivity of magnetic component 122, the combination creates a parallel plate capacitor, with the space between the conductive electrode plate 140 and the magnetic component 122 being filled with air. When coil 131 is energized, an electromagnetic force is generated between the coil 131 and the magnetic component 122, causing the magnetic component 122 to move. As the magnetic component 122 moves, the area of overlap between the magnetic component 122 and the conductive electrode plate 140 changes, which alters the capacitance between them. By detecting these changes in capacitance, the position of the magnetic component 122 can be accurately determined.

The anti-shake motor disclosed in this application uses the magnetic component (122) that works in conjunction with a coil (131) to generate electromagnetic force. Together, these elements form a capacitor with the conductive electrode plate (140). The conductivity of the magnetic component (122) is harnessed to produce a capacitance signal, which correlates to the movement position of the magnetic component. This setup allows for the precise detection of the anti-shake bracket's (120) position.

This method offers several advantages over traditional Hall detection techniques, which are prone to interference from external magnetic fields and temperature fluctuations. Additionally, it eliminates the need for extra mathematical processing that would be required if a magnet were not used as the capacitor's electrode plate. By optimizing the structure of the anti-shake motor to enable closed-loop control, this design reduces the number of necessary components, conserves internal space, and ensures that the motor provides adequate driving force.

In some embodiments of the present application, to effectively detect the position of the anti-shake bracket 120 within a plane perpendicular to the lens's optical axis, multiple magnetic components 122 are utilized. A few of these magnetic components 122 are arranged sequentially along a first direction, while the others are distributed sequentially along a second direction. The first and second directions are perpendicular to each other and lie parallel to a predetermined plane. Multiple coils 131 and conductive electrode plates 140 are also employed, with each coil and each conductive electrode plate 140 corresponding one-to-one with the magnetic components 122.

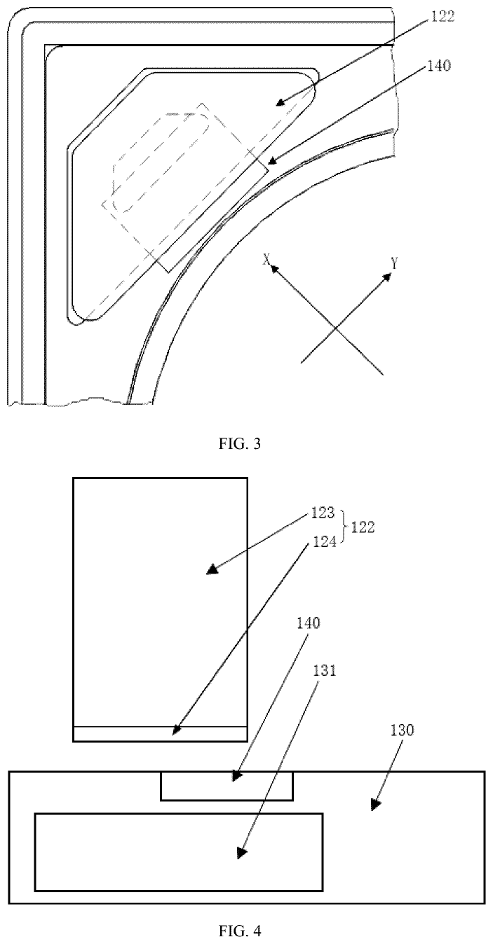

The first and second directions, both within the plane perpendicular to the lens's optical axis, are indicated by the arrows X and Y in FIGS. 2 and 3, respectively. The anti-shake bracket 120 can move along either the first or second direction or simultaneously in both. The drive structure, formed by the coils 131 and magnetic components 122, is configured to operate in both directions. When the coils 131 aligned with the first direction are energized, they create an electromagnetic force that drives the anti-shake bracket 120 in the first direction. Similarly, when the coils 131 aligned with the second direction are energized, the bracket moves in the second direction. Energizing coils in both directions simultaneously cause the bracket to move in the resultant direction of these two forces. Additionally, by altering the current direction in coil 131, the movement direction of the anti-shake bracket 120 can be reversed along the first direction.

Through the measuring of the capacitance due to the interaction of the conductive electrode plates 140 with the magnetic components 122, the position of the anti-shake bracket 120 can be detected as it moves in the first, second, or resultant direction.

The orthographic projection of the conductive electrode plates 140 along the first direction extends at least partially beyond the edge of the corresponding magnetic components 122 in the first direction. However, it remains fully within the boundaries of the magnetic components' edge in the second direction. Throughout the entire movement of the magnetic components 122 in the second direction, this projection stays within the edges of the magnetic components 122. Similarly, when the electrode plates are aligned along the second direction, their projection extends partly beyond the edge of the magnetic components 122 in the second direction but stays entirely within the boundaries of the edge of the magnetic components 122 in the first direction throughout the movement of the magnetic components 122 in the first direction.

The length of the conductive electrode plates 140, when aligned along the first direction, is shorter in the second direction than the length of the corresponding magnetic components 122 in the same direction. As the magnetic components 122 move due to electromagnetic force, the conductive electrode plates 140 do not extend beyond the boundaries of the magnetic components 122 in the second direction. Instead, their overlapping length in the first direction changes, altering the overlapping area between the electrode plates and the magnetic components. In other words, the orthographic projection of the conductive electrode plates 140 along the first direction extends partially beyond the edge of the magnetic components 122 in the first direction but remains within the boundaries of the magnetic components 122 in the second direction throughout the entire movement in the second direction. As a result, the capacitance value formed between the conductive electrode plates 140 and the magnetic components 122 changes linearly with the displacement of the magnetic components 122 in the first direction. When the magnetic components 122 move in the second direction, the facing area with the corresponding conductive electrode plates 140 remains constant.

Similarly, the length of the conductive plate 140 distributed along the second direction is shorter than the length of the magnetic component 122 in the second direction. During the movement of the magnetic component 122 driven by electromagnetic force, the conductive plate 140 distributed along the second direction remains aligned with the corresponding magnetic component 122 in the first direction. Instead, resulting only changes in overlapping length in the second direction. This change alters in the overlapping area between them.

In other words, the projection of the conductive plate 140 onto the magnetic component 122 in the second direction will partially extend beyond the edge of the magnetic component 122, while in the first direction, it remains within the boundary of the magnetic component 122. Throughout the entire movement of magnetic component 122 in the first direction, it stays within the bounds of magnetic component 122. Consequently, the capacitance between the two components will vary linearly with the displacement of the magnetic component 122 in the second direction. However, when the magnetic component 122 moves in the first direction, the overlapping area with the conductive plate 140 remains unchanged.

Therefore, the position of the anti-shake bracket 120 can be accurately detected during its movement in the first direction using the conductive plate 140 that is aligned in that direction. Similarly, when the anti-shake bracket 120 moves in the second direction, its position is detected through a separate conductive plate 140 aligned with that second direction. Since these two detection systems operate independently, they do not interfere with each other. This separation simplifies the correlation between the capacitive signals and the position of the anti-shake bracket 120, leading to improved precision in tracking the movement of the anti-shake bracket 120.

In some embodiments of this application, at least two magnetic components 122 are distributed along the first direction, or the second direction or both. This configuration allows for differential processing of the capacitive signals generated between the magnetic components 122 and the conductive plates 140. As a result, the detection outcomes are enhanced, providing greater robustness and accuracy.

As shown in FIG. 2, there are four magnetic components 122, which are distributed at the four corners of the base 110. Simultaneously, four corresponding coils 131 and four corresponding conductive plates 140 are also distributed at the four corners of the base 110. In the first direction and the second direction, there are two conductive plates 140 that can form capacitive signals with the corresponding magnetic components 122. When the anti-shake bracket 120 moves in the first direction or the second direction, the differential signal formed by the two capacitive signals can achieve accurate detection of the position of the anti-shake bracket 120.

In some embodiments of this application, the conductive plate 140 may be copper laid on the surface of the circuit board 130.

Copper laying refers to the metal copper material laid on the surface of the circuit board 130. Since the magnetic permeability of copper is the same as that of air, both being 4π×107H/m (Henries per meter), i.e., the relative permeability is 1, conductive plate 140 does not affect the magnetic field between coil 131 and magnetic component 122. That is, it does not affect the driving process of coil 131 on magnetic component 122.

In addition, coil 131 is set on the surface of the circuit board 130 away from the magnetic component 122, and the conductive plate 140 is located between the coil 131 and the magnetic component 122.

Coil 131 can be realized by multilayer wiring on the circuit board 130, achieving the same effect as the coil 131 wound with copper wire, but with smaller size, flexible design, and convenient assembly. For example, wiring can be arranged on an FPC to achieve the arrangement of the coil 131, making the coil 131 an integral structure with the circuit board 130, directly achieving conduction within the circuit board 130.

The conductive electrode plate 140 is located between the coil 131 and the magnetic component 122, that is, the coil 131 and the conductive electrode plate 140 are both opposite the surface of the magnetic component 122 that is perpendicular to the lens optical axis. At this time, when the magnetic component 122 moves, the direct-facing area between the conductive electrode plate 140 and the magnetic component 122 will change accordingly, and then the position of the anti-shake bracket 120 can be detected by detecting the change in the capacitive signal.

Since the conductive electrode plate 140 does not affect the magnetic field between the coil 131 and the magnetic component 122, as shown in FIG. 4, there is an overlapping area between the coil 131 and the conductive electrode plate 140 in the direction perpendicular to the circuit board 130. By arranging the conductive electrode plate 140 to overlap with the coil 131 in the direction perpendicular to the circuit board 130, the internal space occupied by the anti-shake motor can be further reduced, avoiding the design and installation of other components.

In addition, the conductive electrode plate 140 can also be arranged in a direction parallel to the lens optical axis, that is, the circuit board 130 includes a first part and a second part. The first part is set on the base 110, and the second part extends from the first part in a direction perpendicular to the predetermined plane. Coil 131 is set on the first part, and the coil 131 is opposite the surface of the magnetic component 122 that is perpendicular to the lens optical axis. The conductive electrode plate 140 is set on the second part, and the conductive electrode plate 140 is opposite the surface of the magnetic component 122 that is parallel to the lens optical axis. At this time, when the magnetic component 122 moves, the distance between the conductive electrode plate 140 and the magnetic component 122 will change accordingly, and then the position of the anti-shake bracket 120 can be detected by detecting the change in the capacitive signal.

In some embodiments of this application, as shown in FIG. 4, the magnetic component 122 may include a magnet 123 and a metal layer 124 disposed on the surface of the magnet 123. The metal layer is mostly nickel plating.

Magnet 123 can be a neodymium iron boron magnet, so that the magnet 123 itself has conductivity. Moreover, nickel is plated on the surface of magnet 123 so that magnet 123 can be used as a capacitive plate.

In addition, the connection between the anti-shake bracket 120 and the base 110 can be achieved through a suspension wire 151, that is, the anti-shake motor may also include a suspension wire assembly 150, the anti-shake bracket 120 is connected to the suspension wire assembly 150 and is supported on the base 110 by the suspension wire assembly 150, and the magnetic component 122 is electrically connected to the circuit board 130 via the suspension wire assembly 150.

As shown in FIG. 1, the lens bracket 200 is connected to the anti-shake bracket 120 through an elastic piece assembly 160 formed by four upper elastic pieces 161 and four lower elastic pieces (not shown in the figure), so that the lens bracket 200 can move along the direction of the lens optical axis to achieve focusing. The four upper elastic pieces 161 are correspondingly connected to one end of the four suspension wires 151, and the other end of the four suspension wires 151 is respectively fixed at the four corners of the base 110. The anti-shake bracket 120 is mounted on base 110 through the suspension wire 151, realizing the movement of the anti-shake bracket 120 relative to the base 110. When coil 131 is energized, the anti-shake bracket 120 is driven to move through the electromagnetic force between the coil 131 and the magnet to achieve anti-shake. Moreover, the suspension wires 151 and the elastic pieces 161 can be made of conductive materials, such as metal materials, the suspension wires 151 and the upper elastic pieces 161 are welded together, and the upper elastic pieces 161 are connected to the magnet through conductive glue or low-temperature welding. As shown in FIG. 5, the suspension wires 151 are also welded to the circuit board 130, so that each magnet can realize the electrical connection between the magnet and the circuit board 130 through an upper elastic piece 161 and a suspension wire 151, thereby transmitting the capacitive signal formed by the magnet and the conductive electrode plate 140 to the driving chip of the camera module via the circuit board 130. Some embodiments of this application also provide a camera module, including the above-mentioned anti-shake motor, and the anti-shake motor also includes a lens bracket 200 connected to the anti-shake bracket 120. The lens bracket 200 is provided with a mounting hole 210; the camera module also includes a lens and a driving chip 170. The lens is set in the mounting hole 210 of the lens bracket 200; the driving chip is electrically connected to the circuit board 130, and the driving chip 170 is used to receive the capacitive signal and send a control signal to the coil 131 according to the capacitive signal.

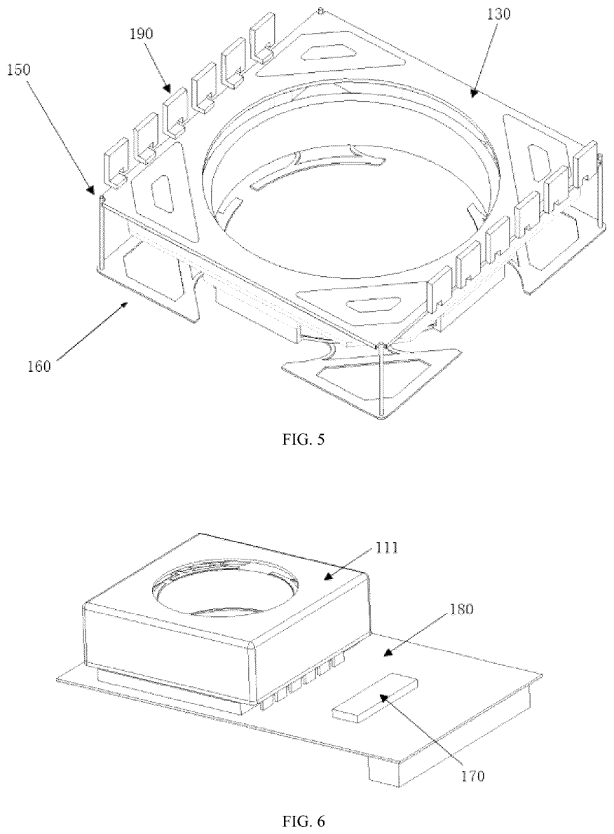

As shown in FIG. 6, the driving chip 170 is set on the circuit board 180 of the camera module, and the circuit board 130 of the anti-shake motor is connected to the circuit board 180 of the camera module through pins 190, and thus realizes the electrical connection with the driving chip 170. At the same time, the housing 111 shown in FIG. 6 can protect the lens in the camera module.

Some embodiments of this application also provide an electronic device, including the above-mentioned camera module. The electronic device can be a smart electronic device with a camera function such as a mobile phone, tablet, or laptop. Those skilled in the art can understand that the above-mentioned embodiments are specific implementations of this application. In actual applications, various changes can be made in form and detail without departing from the spirit and scope of this application.

What is claimed is:

1. An anti-shake motor, comprising:
a base;
an anti-shake bracket movably mounted on the base, the anti-shake bracket further comprising a conductive magnetic component;
a circuit board mounted on the base, wherein the circuit board further comprising a coil configured to drive the magnetic component to move the anti-shake bracket within a predetermined plane;
a conductive electrode plate positioned on the circuit board and opposite the magnetic component to form a capacitor, wherein the magnetic component is electronically connected to the circuit board, and the circuit board outputs a capacitance signal of the capacitor.

2. The anti-shake motor of claim 1, wherein the magnetic component, coil, and conductive electrode plate each comprise a plurality of units, with the magnetic components distributed in a first direction and a second direction, wherein the first direction and the second direction are perpendicular to each other and both parallel to the predetermined plane, and each magnetic component corresponding to a coil and a conductive electrode plate.

3. The anti-shake motor of claim 2, wherein an orthographic projection of the conductive electrode plate distributed along the first direction on the corresponding magnetic component at least partially falls outside an edge of the magnetic component in the first direction and within an edge of the magnetic component in the second direction, and remains within the edge of the magnetic component throughout any movement of the magnetic component along the second direction.

4. The anti-shake motor of claim 2, wherein orthographic projection of the conductive electrode plate distributed along the second direction on the corresponding magnetic component at least partially falls outside an edge of the magnetic component in the second direction and within an edge of the magnetic component in the first direction, and remains within edges of the magnetic component throughout any movement of the magnetic component along the first direction.

5. The anti-shake motor of claim 2, wherein at least two magnetic components are distributed along the first direction.

6. The anti-shake motor of claim 2, wherein at least two magnetic components are distributed along the second direction.

7. The anti-shake motor of claim 1, wherein the conductive electrode plate is a copper foil incorporated in a surface of the circuit board.

8. The anti-shake motor of claim 7, wherein the coil is configured adjacent to a surface of the circuit board opposite the magnetic component, and the conductive electrode plate is positioned between the coil and the magnetic component.

9. The anti-shake motor of claim 1, wherein the magnetic component comprises a magnet and a metal layer disposed on a surface of the magnet.

10. The anti-shake motor of claim 1, further comprising a suspension wire assembly, wherein the anti-shake bracket is connected to and supported on the base by the suspension wire assembly, and the magnetic component is electrically connected to the circuit board via the suspension wire assembly.

11. A camera module, comprising:
an anti-shake motor, wherein the anti-shake motor comprises: a base; an anti-shake bracket movably mounted on the base, the anti-shake bracket further comprising a conductive magnetic component; a circuit board mounted on the base, wherein the circuit board further comprising a coil configured to drive the magnetic component to move the anti-shake bracket within a predetermined plane; and a conductive electrode plate positioned on the circuit board and opposite the magnetic component to form a capacitor, wherein the magnetic component is electronically connected to the circuit board, and the circuit board outputs a capacitance signal of the capacitor,
a lens holder connected to the anti-shake bracket, wherein the lens holder has a mounting hole;
a lens disposed within the mounting hole; and
a driving chip electrically connected to the circuit board, wherein the driving chip is configured to receive the capacitive signal and based on the capacitive signal, transmit a control signal to the circuit board for controlling the coil.
